(19) United States
(12) Patent Application Publication
(10) Pub. No.: US 2024/0159103 A1
(43) Pub. Date: May 16, 2024

(54) Shooter Protection Assembly

(71) Applicant: Robert Flores, San Francisco, CA (US)

(72) Inventor: Robert Flores, San Francisco, CA (US)

(21) Appl. No.: 17/988,523

(22) Filed: Nov. 16, 2022

(51) Int. Cl. E06B 9/68; E06B 9/15; F41H 5/013; G06V 20/52; G06V 40/10; H04N 7/18

(52) U.S. Cl. CPC E06B 9/68; E06B 9/15; F41H 5/013; G06V 20/52; G06V 40/10; H04N 7/181; E06B 2009/6818; H04N 5/2251

(57) ABSTRACT

A shooter protection assembly includes a building that has a plurality of doors to enter the building. The doors are positioned at pre-determined locations on an exterior wall of the building. A control unit is positioned in the building such that the control unit is accessible to an authorized user and the control unit stores image analysis software. A plurality of surveillance cameras is each mounted to the building to capture imagery of people approaching the building. A plurality of door covers is each aligned with a respective one of the doors. The control unit actuates each of the door covers into a deployed condition when the control unit identifies a person carrying a firearm to inhibit the person carrying the firearm from entering the building.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to protection devices and more particularly pertains to a new protection device for protecting occupants of a building from a person with a firearm. The device includes a plurality of surveillance cameras distributed around a building and a control unit that analyzes imagery from the surveillance cameras. The device includes a plurality of door covers that is each attached to the building and aligned with a respective door of the building. Each of the door covers is actuated into a deployed position to cover the respective door when the control unit determines a person carrying a firearm is approaching the building.

### (2) Description of Related Art Including Information Disclosed Under 37 CFR 1.97 and 1.98

The prior art relates to protection devices including a ballistic curtain that is deployed with an airbag inflator. The prior art discloses a ballistic shade that includes a motorized roller for deploying over a window. The prior art discloses a ballistic protection device that includes a blind comprised of a plurality of slats that is automatically deployed over a window with an automated control unit. The prior art discloses a physical barrier device for selectively covering a window that includes lights, sirens and electronic locks. The prior art discloses a building segregation device that includes ballistic barriers that are automatically deployed to segregate areas of a building.

### BRIEF SUMMARY OF THE INVENTION

An embodiment of the disclosure meets the needs presented above by generally comprising a building that has a plurality of doors to enter the building. The doors are positioned at pre-determined locations on an exterior wall of the building.

A control unit is positioned in the building such that the control unit is accessible to an authorized user and the control unit stores image analysis software. A plurality of surveillance cameras is each mounted to the building to capture imagery of people approaching the building. A plurality of door covers is each aligned with a respective one of the doors. The control unit actuates each of the door covers into a deployed condition when the control unit identifies a person carrying a firearm to inhibit the person carrying the firearm from entering the building.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a shooter protection assembly according to an embodiment of the disclosure.

FIG. 2 is a perspective in-use view of an embodiment of the disclosure showing a plurality of door covers in a retracted condition.

FIG. 3 is a perspective in-use view of an embodiment of the disclosure showing a plurality of door covers in a deployed condition.

FIG. 4 is a right side view of an embodiment of the disclosure.

FIG. 5 is a cut-away view of a door cover of an embodiment of the disclosure.

### DETAILED DESCRIPTION OF THE INVENTION

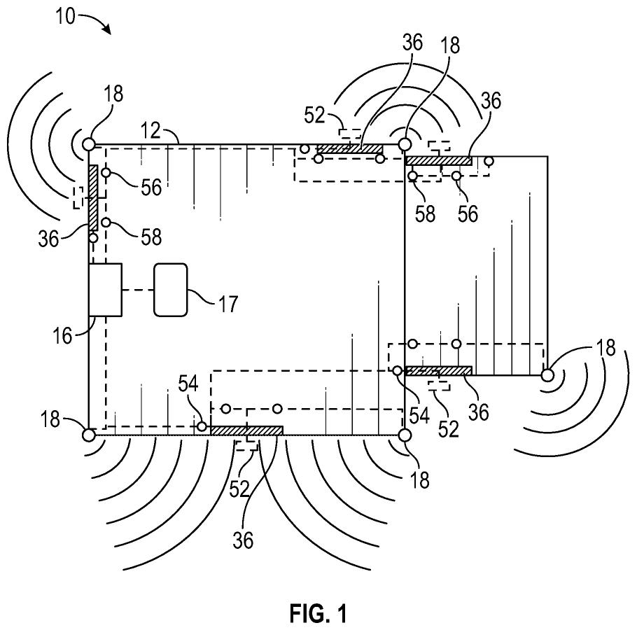

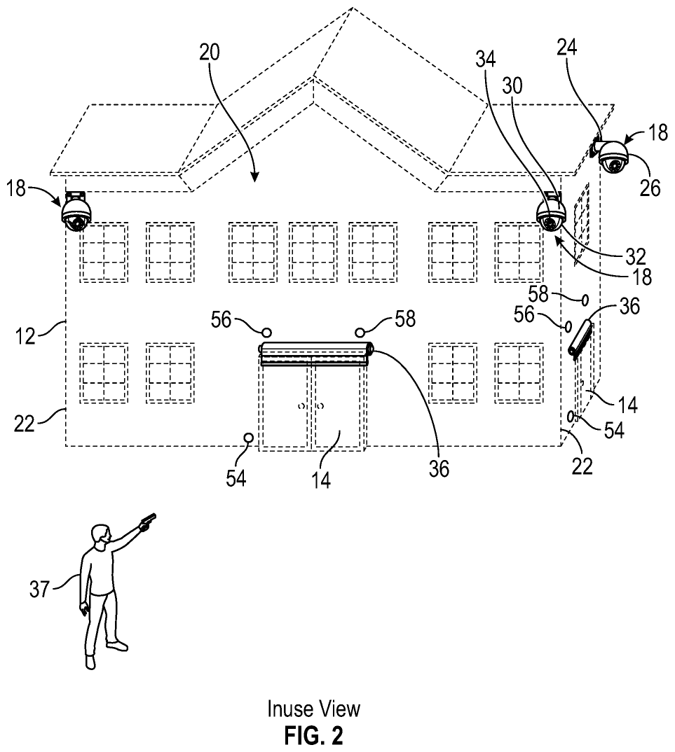

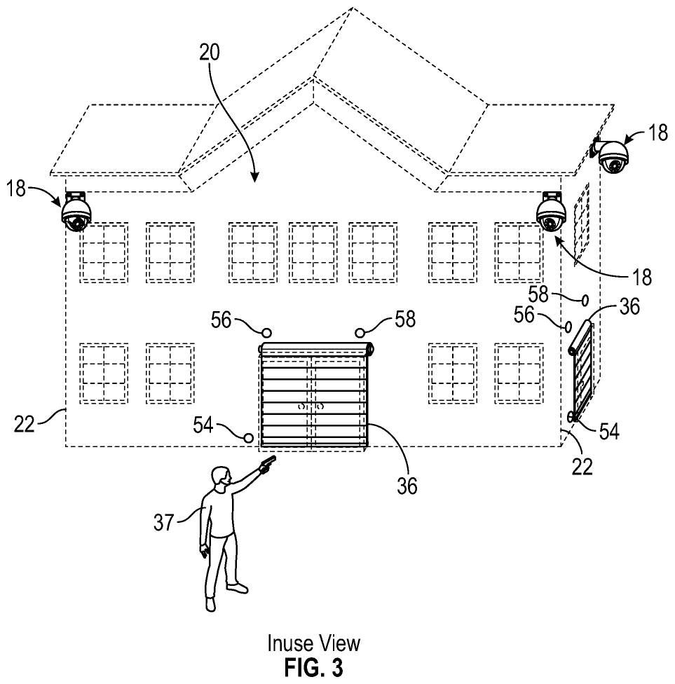

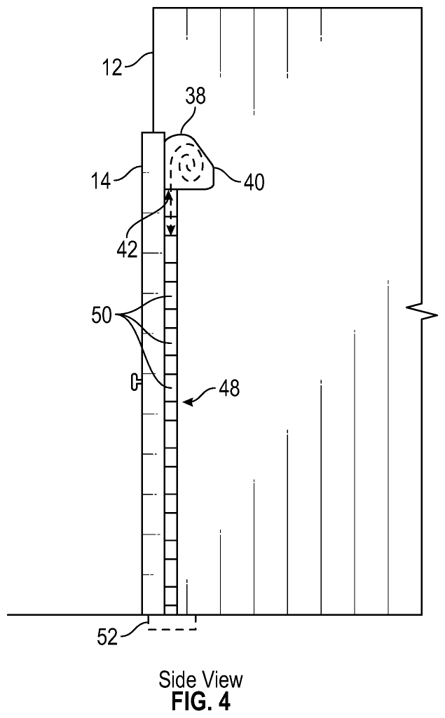

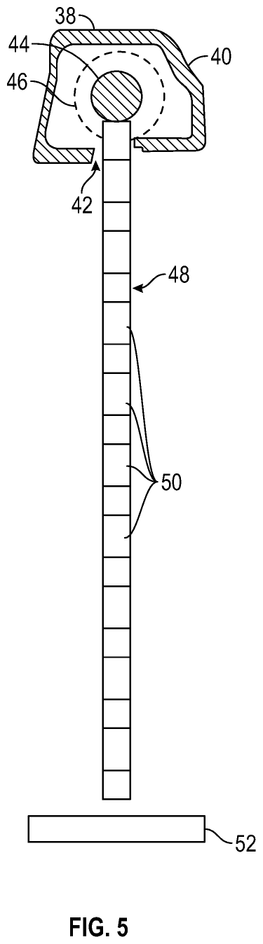

With reference now to the drawings, and in particular to FIGS. 1 through 5 thereof, a new protection device embodying the principles and concepts of an embodiment of the disclosure and generally designated by the reference numeral 10 will be described.

As best illustrated in FIGS. 1 through 5, the shooter protection assembly 10 generally comprises a building 12 that has a plurality of doors 14 to enter the building 12 and the doors 14 are positioned at pre-determined locations on an exterior wall 15 of the building 12. The building 12 may be a public building 12 such as a school or a hospital, a private building 12 such as a house or any other type of occupancy. A control unit 16 is positioned in the building 12 such that the control unit 16 is accessible to an authorized user. The control unit 16 is electrically coupled to a power source 17 comprising an electrical system of the building 12 and the control unit 16 stores image analysis software. The control unit 16 may include a user interface, such as a keyboard and a monitor for example, and the authorized user may be an occupant of the building 12. Furthermore, the control unit 16 may be in communication with a control center, such as a third party security company for example, and the authorized user may be a person located at the control center.

A plurality of surveillance cameras 18 is provided and each of the surveillance cameras 18 is mounted to the building 12. Each of the surveillance cameras 18 is positioned at strategic locations on an exterior 20 of the building 12 to capture imagery of people approaching the building 12. Each of the surveillance cameras 18 is in communication with the control unit 16 thereby facilitating the analysis software to analyze imagery captured by the surveillance cameras 18. The analysis software may be software designed to detect firearms or other weapons being carried by the people approaching the building 12. Each of the surveillance cameras 18 may be aligned with a respective corner 22 of the building 12 or otherwise arranged to maximize the efficiently with which the surveillance cameras 18 can monitor the area around the building 12.

Each of the surveillance cameras 18 has a mount 24 and a lens housing 26 and the mount 24 of each of the surveillance cameras 18 is attached to the exterior wall 15 of the building 12. The mount 24 of each of the surveillance cameras 18 is positioned adjacent to a roof 28 of the building 12. The lens housing 26 comprises a cup 30 and a ball 32 that is rotatably disposed in the cup 30. The cup 30 of the lens housing 26 is attached to the mount 24 such that the ball 32 is directed downwardly from the cup 30. Additionally, each of the surveillance cameras 18 includes a lens 34 that is integrated into the ball 32 and each of the surveillance cameras 18 is electrically coupled to the control unit 16. Each of the surveillance cameras 18 may be digital video cameras or any other type of electronic surveillance camera employed for closed circuit surveillance.

A plurality of door covers 36 is provided and each of the door covers 36 is coupled to the building 12. Each of the door covers 36 is aligned with a respective one of the doors 14 and each of the door covers 36 is in communication with the control unit 16. Furthermore, the control unit 16 actuates each of the door covers 36 into a deployed condition having each of the door covers 36 covering the respective door 14 in the building 12 when the control unit 16 identifies a person carrying a firearm 37. In this way the plurality of door covers 36 inhibit the person carrying the firearm 37 from entering the building 12. Additionally, each of the door covers 36 is comprised of a bullet resistant material, including but not being limited to a synthetic, woven fiber commonly employed in ballistic vests, to inhibit a bullet from the firearm from penetrating the door covers 36. Each of the door covers 36 is actuated into a retracted condition thereby exposing the respective door 14 when the control unit 16 receives an all clear input from the authorized user.

Each of the door covers 36 comprises a housing 38 has an outer wall 40 and the housing 38 has a dispensing opening 42 extending through the outer wall 40. The housing 38 is attached to the exterior wall 15 of the building 12 and the housing 38 is positioned above the respective door 14 having the dispensing opening 42 being directed toward the respective door 14. The housing 38 may be an elongated cylinder that extends along with full width of the respective door 14. Each of the door covers 36 includes a roller 44 that is rotatably disposed in the housing 38 and the roller 44 is oriented to have a horizontal rotational axis. Furthermore, the roller 44 extends along a full length of the housing 38.

Each of the door covers 36 includes a motor 46 that is attached to the roller 44. The motor 46 rotates the roller 44 in either a first direction or a second direction when the motor 46 is turned on and the motor 46 is electrically coupled to the control unit 16. The motor 46 is turned on to rotate the roller 44 in the first direction when the control unit 16 indentifies the person carrying the firearm 37. The motor 46 is turned on to rotate the roller 44 in the second direction when the control unit 16 receives the all clear input from the authorized user. The motor 46 may comprise a two direction electric motor or the like.

Each of the door covers 36 includes a panel 48 which comprises a plurality of hinged sections 50 that are hingedly attached together. The plurality of hinged sections 50 is vertically stacked and each of the hinged sections 50 is comprised of a bullet resistant material. The panel 48 is wrapped around the roller 44 when the motor 46 rotates in the second direction for storing the panel 48 in the housing 38. Conversely, the panel 48 is unwrapped from the roller 44 and extends outwardly from the dispensing opening 42 in the outer wall 40 of the housing 38 when the motor 46 rotates in the first direction for deploying the panel 48 to cover the respective door 14. In this way the doors 14 to the building 12 are automatically covered to protect the occupants 51 of the building 12 from the person with the firearm.

Each of the door covers 36 includes a lock 52 that is integrated into the ground such that the lock 52 is aligned with the respective door 14. The lock 52 is electrically coupled to the control unit 16 and the lock 52 engages a respective one of the hinged sections 50 of the panel 48 when the panel 48 is deployed to cover the respective door 14 to lock the panel 48 over the respective door 14. The lock 52 disengages the respective hinged section 50 when the control unit 16 receives the all clear input to facilitate the panel 48 to be wrapped around the roller 44. The lock 52 may comprise a latch that releasably engages the respective hinged section 50, a magnet that magnetically engages a magnetic plate on the respective hinged section 50 or any other type of electro-mechanical lock that can releasably engage the respective hinged section 50.

A plurality of motion sensors 54 is provided and each of the plurality of motion sensors 54 is integrated into a respective one of the doors 14 in the building 12 for detecting if an individual is standing in the respective door 14. Each motion sensor 54 is electrically coupled to the motor 46 associated with the door cover 36 aligned with the respective door 14. The motor 46 associated with the door cover 36 aligned with the respective door 14 is inhibited from being actuated to rotate the roller 44 associated with the door cover 36 aligned with the respective door 14 when the motion sensor 54 in the respective door 14 senses an individual in the respective door 14. In this way the individual is protected from being injured by the door cover 36.

A plurality of light emitters 56 is each disposed above a respective door 14 and each of the light emitters 56 is electrically coupled to the control unit 16. Each of the light emitters 56 is turned on when the door covers 36 are actuated into the deployed condition. In this way a hearing impaired individual is visually notified that the door covers 56 are about to be deployed. Additionally, a plurality of alarms 58 is each positioned adjacent to a respective door 14 and each of the alarms 58 is electrically coupled to the control unit 16. Each of the alarms 58 is actuated to emit an audible alert when the door covers 36 are actuated into the deployed condition. In this way a visually impaired user is audibly notified that the door covers 36 are about to be deployed.

In use, the door covers 36 are actuated into the deployed condition when the image analysis software determines that a person approaching the building 12 is carrying a firearm. In this way the person carrying the firearm 37 is inhibited from entering the building 12 or from firing a bullet through any of the doors 14. Thus, the occupants 51 of the building 12 are protected from the person carrying the firearm 37 until law enforcement can arrive. The plurality of door covers 36 are actuated into the retracted condition when the authorized user enters the all clear input into the control unit 16. In this way the occupants 51 of the building 12 can exit the building 12 when law enforcement has secured the person carrying the firearm 37 and eliminated any danger to the occupants 51.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shooter protection assembly for protecting a building from an active shooter, said assembly comprising:
a building having a plurality of doors to enter said building, said doors being positioned at pre-determined locations on an exterior wall of said building;
a control unit being positioned in said building such that said control unit is accessible to an authorized user, said control unit being electrically coupled to a power source comprising an electrical system of said building, said control unit storing image analysis software;
a plurality of surveillance cameras, each of said surveillance cameras being mounted to said building, each of said surveillance cameras being positioned at strategic locations on an exterior of said building wherein said surveillance cameras are configured to capture imagery of people approaching said building, each of said surveillance cameras being in communication with said control unit thereby facilitating said analysis software to analyze imagery captured by said surveillance cameras; and
a plurality of door covers, each of said door covers being coupled to said building, each of said door covers being aligned with a respective one of said doors, each of said door covers being in communication with said control unit, said control unit actuating each of said door covers into a deployed condition having each of said door covers covering said respective door in said building when said control unit identifies a person carrying a firearm wherein said plurality of door covers is configured to inhibit the person carrying the firearm from entering said building, each of said door covers being comprised of a bullet resistant material wherein said door covers are configured to inhibit a bullet from the firearm from penetrating said door covers.

2. The assembly according to claim 1, wherein each of said surveillance cameras has a mount and a lens housing, said mount of each of said surveillance cameras being attached to said exterior wall of said building, said mount of each of said surveillance cameras being positioned adjacent to a roof of said building, said lens housing comprising a cup and a ball being rotatably disposed in said cup, said cup of said lens housing being attached to said mount such that said ball is directed downwardly from said cup, each of said surveillance cameras including a lens being integrated into said ball, each of said surveillance cameras being electrically coupled to said control unit.

3. The assembly according to claim 1, wherein each of said door covers comprises a housing having an outer wall, said housing having a dispensing opening extending through said outer wall, said housing being attached to said exterior wall of said building, said housing being positioned above said respective door having said dispensing opening being directed toward said respective door.

4. The assembly according to claim 3, wherein each of said door covers comprises:
a roller being rotatably disposed in said housing, said roller being oriented to have a horizontal rotational axis; and
a motor being attached to said roller, said motor rotating said roller in either a first direction or a second direction when said motor is turned on, said motor being electrically coupled to said control unit, said motor being turned on to rotate said roller in said first direction when said control unit indentifies the person carrying the firearm, said motor being turned on to rotate said roller in said second direction when said control unit receives an all clear input from the authorized user.

5. The assembly according to claim 4, wherein each of said door covers comprises a panel comprising a plurality of hinged sections being hingedly attached together, said plurality of hinged sections being vertically stacked, each of said hinged sections being comprised of a bullet resistant material, said panel being wrapped around said roller when said motor rotates in said second direction for storing said panel in said housing, said panel being unwrapped from said roller and extending outwardly from said dispensing opening in said outer wall of said housing when said motor rotates in said first direction for deploying said panel to cover said respective door.

6. The assembly according to claim 5, wherein each of said door covers includes a lock being integrated into the ground such that said lock is aligned with said respective door, said lock being electrically coupled to said control unit, said lock engaging a respective one of said hinged sections of said panel when said panel is deployed to cover said respective door to lock said panel over said respective door, said lock disengaging said respective hinged section when said control unit receives said all clear input to facilitate said panel to be wrapped around said roller.

7. A shooter protection assembly for protecting a building from an active shooter, said assembly comprising:
a building having a plurality of doors to enter said building, said doors being positioned at pre-determined locations on an exterior wall of said building;
a control unit being positioned in said building such that said control unit is accessible to an authorized user, said control unit being electrically coupled to a power source comprising an electrical system of said building, said control unit storing image analysis software;
a plurality of surveillance cameras, each of said surveillance cameras being mounted to said building, each of said surveillance cameras being positioned at strategic locations on an exterior of said building wherein said surveillance cameras are configured to capture imagery of people approaching said building, each of said surveillance cameras being in communication with said control unit thereby facilitating said analysis software to analyze imagery captured by said surveillance cameras, each of said surveillance cameras having a mount and a lens housing, said mount of each of said surveillance cameras being attached to said exterior wall of said building, said mount of each of said surveillance cameras being positioned adjacent to a roof of said building, said lens housing comprising a cup and a ball being rotatably disposed in said cup, said cup of said lens housing being attached to said mount such that said ball is directed downwardly from said cup, each of said surveillance cameras including a lens being integrated into said ball, each of said surveillance cameras being electrically coupled to said control unit; and
a plurality of door covers, each of said door covers being coupled to said building, each of said door covers being aligned with a respective one of said doors, each of said door covers being in communication with said control unit, said control unit actuating each of said door covers into a deployed condition having each of said door covers covering said respective door in said building when said control unit identifies a person carrying a firearm wherein said plurality of door covers is configured to inhibit the person carrying the firearm from entering said building, each of said door covers being comprised of a bullet resistant material wherein said door covers are configured to inhibit a bullet from the firearm from penetrating said door covers, each of said door covers comprising:
a housing having an outer wall, said housing having a dispensing opening extending through said outer wall, said housing being attached to said exterior wall of said building, said housing being positioned above said respective door having said dispensing opening being directed toward said respective door;
a roller being rotatably disposed in said housing, said roller being oriented to have a horizontal rotational axis;
a motor being attached to said roller, said motor rotating said roller in either a first direction or a second direction when said motor is turned on, said motor being electrically coupled to said control unit, said motor being turned on to rotate said roller in said first direction when said control unit indentifies the person carrying the firearm, said motor being turned on to rotate said roller in said second direction when said control unit receives an all clear input from the authorized user;
a panel comprising a plurality of hinged sections being hingedly attached together, said plurality of hinged sections being vertically stacked, each of said hinged sections being comprised of a bullet resistant material, said panel being wrapped around said roller when said motor rotates in said second direction for storing said panel in said housing, said panel being unwrapped from said roller and extending outwardly from said dispensing opening in said outer wall of said housing when said motor rotates in said first direction for deploying said panel to cover said respective door; and
a lock being integrated into the ground such that said lock is aligned with said respective door, said lock being electrically coupled to said control unit, said lock engaging a respective one of said hinged sections of said panel when said panel is deployed to cover said respective door to lock said panel over said respective door, said lock disengaging said respective hinged section when said control unit receives said all clear input to facilitate said panel to be wrapped around said roller.
